(19) United States
(12) Patent Application Publication
(10) Pub. No.: US 2018/0032214 A1
(43) Pub. Date: Feb. 1, 2018

(54) Interior Design System Using Real-Time Rendering Technology

(71) Applicant: Vidahouse Holdings Co., Ltd., Shanghai City (CN)

(72) Inventor: Wei Hsien Chen, Shanghai City (CN)

(21) Appl. No.: 15/223,966

(22) Filed: Jul. 29, 2016

(51) Int. Cl. G06F 3/0482; G06T 3/40; G06F 3/0484; G06T 17/20; G06T 19/00

(52) U.S. Cl. CPC G06F 3/0482; G06T 17/20; G06T 19/003; G06F 3/04847; G06T 3/4038; G06T 2210/04; G06T 2200/24

(57) ABSTRACT

3D reality rendering technology is embodied in computational apparatus and automated process for interior space design, with which combinations of interior space design elements can be extracted, saved, and be applied to other spaces. A system and data structure for saving and loading coded elements are created to allow design elements to be applied into new projects where these elements form new space characteristics. Thus, time-consuming limitations of conventional 3D design software are overcome, for example, by enabling repetition of same working process in allocating design elements into the interior space. In this way, design elements are not rebuilt or allocated manually for every project, and preferably only material or shape of elements may be changed. Furthermore, by using internet and 3D rendering technologies to share combinations of interior design elements to other user's design project, the design process is shortened to save time. In particular, one or more element is analyzed and coded automatically into a database, where element characteristics are categorized into parameter groups; such elements may be applied into certain space as a set of “DNA”, and can be changed freely by users, and design proposals can thereby be created more quickly. Preferably, a computational apparatus includes a coding system of design elements, a searching method using code values, and certain types of elements being interchangeable with 3D rendering. Thus, the design process may be shorten and optimized by applying combinations of design elements, and design results are adjustable, and shareable among users, thereby accumulating huge numbers of “DNA”s in the database. Optionally, processor automates design-by-list approach, wherein in website or application, one or more user may generate design by creating a list of interior items, and processor or server automatically generates panorama view of such design in the space; preferably, user may repeat the process, and change items in the list, such that processor/server creates panorama and sends to user device according to latest change.

### FIELD OF INVENTION

The invention pertains generally to the field of computer-implemented systems and methods, and more particularly to automated implementation of 3D reality rendition of interior space design.

### BACKGROUND OF INVENTION

Computer-implemented design systems provide software tools for automatically prototyping designs. However, such automated tools are conventionally limited due to time-consuming approaches that still hamper practical sharing of design elements.

### SUMMARY

Generally, it is contemplated herein that novel 3D-reality rendering apparatus and/or computer-implemented process enables network-accessible interior space design. In one embodiment, a network-accessible processor computationally renders interior space design elements to be extracted, saved, and applied automatically for 3D-reality space design, for example, whereby computationally rendered 3D-reality space design transforms such rendered design physically to actual 3D interior space. Optionally, at least one processor saves or loads coded elements that allow design elements to be applied into project(s) where coded and/or design elements form space characteristics. Such processor may enable such elements to be analyzed and/or coded into one or more database; whereupon element characteristics being categorized into parameter groups, such elements being applied into design space(s) as a set of “DNA” that may be user-changeable for alternate design proposal. Also, such processor may code design elements, search using code values, and/or interchange element types with 3D rendering. Furthermore, such processor may enable virtual-reality 3D walk-thru among communicating user, buyer, designer, or supplier to facilitate real-time interaction and design idea sharing. Optionally, processor automates design-by-list approach, wherein in website or application, one or more user may generate design by creating a list of interior items, and processor or server automatically generates panorama view of such design in the space; preferably, user may repeat the process, and change items in the list, such that processor/server creates panorama and sends to user device according to latest change.

### BRIEF DESCRIPTION OF FIGURES

FIG. 1 illustrates representative apparatus embodiment diagram for rendering design according to one or more aspect of the present invention.

FIG. 2 illustrates representative apparatus embodiment diagram particularly system structure for rendering design according to one or more aspect of the present invention.

FIG. 3 illustrates representative apparatus embodiment diagram particularly system structure for rendering design according to one or more aspect of the present invention.

FIG. 4 illustrates representative apparatus and method embodiment diagram particularly work flow product for rendering design according to one or more aspect of the present invention.

FIG. 5 illustrates representative apparatus and method embodiment diagram particularly work flow design for rendering design according to one or more aspect of the present invention.

FIG. 6 illustrates representative apparatus and method embodiment diagram particularly work flow panorama design for rendering design according to one or more aspect of the present invention.

FIG. 7 illustrates representative apparatus and method embodiment diagram particularly asset reusable system for rendering design according to one or more aspect of the present invention.

FIGS. 8-22 illustrate representative user interface diagrams for rendering design according to one or more aspect of the present invention.

FIGS. 23-25 illustrate representative data, storage, and data structure for rendering design according to one or more aspect of the present invention.

FIG. 26 illustrates representative hardware apparatus embodiment diagram for rendering design according to one or more aspect of the present invention.

### DETAILED DESCRIPTION

Preferably, 3D reality rendering technology is embodied in computational apparatus and automated process for interior space design, with which combinations of interior space design elements can be extracted, saved, and be applied to other design spaces. A computer-aided system and data structure for saving and/or loading coded elements are created to allow design elements to be applied selectively into new projects where these elements form personalizable space characteristics. Thus, time-consuming limitations of conventional 3D design software are overcome, for example, by enabling repetition of same working process in allocating design elements into the interior space. In this advantageous manner, design elements are not rebuilt or allocated manually for every project, and preferably only material or shape of elements may be changeable. Furthermore, by using internet cloud access and 3D rendering design technologies to share combinations of interior design elements for other user design project, the design process generally is shortened to save time overall. Moreover, in particular, one or more element may be analyzed and coded automatically into a database, wherein element characteristics are categorized into parameter groups; such elements being applicable into certain space as a set of unique “DNA”, which can be changed freely by users, and thus design proposals can thereby be created more quickly. Preferably, a network-accessible computational apparatus includes an automated coding system of design elements, a software-based searching method using code values, and certain types of data structure elements being interchangeable with 3D rendering. Thus, as described herein, one or more novel design process is effectively shortened and optimized by applying combinations of design elements, and design results are adjustable, and hence shareable among users, thereby accumulating huge numbers of unique “DNA”s in the database.

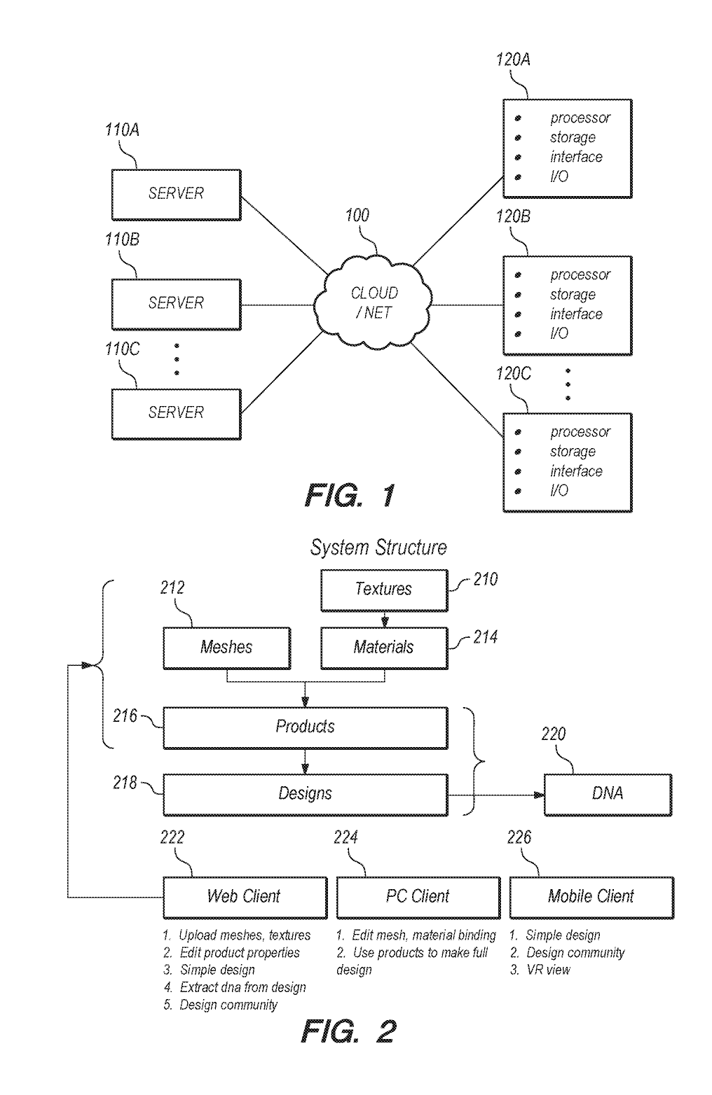

FIG. 1 illustrates representative apparatus embodiment diagram for rendering design according to one or more aspect of the present invention. It is contemplated herein that one or more inventive aspects may be embodied in one or more computing or communication device, network server and/or client device, peer, controller node, or other functionally equivalent electronic signal processing machine, firmware, and/or software accessible via one or more wired and/or wireless network. For example, as shown various servers 110 A/B/C couple via cloud network 100 to various client computers 120 A/B/C having processor, storage, interface, and input/output for implementing one or more 3D-reality rendering capability to provide network-accessible interior space design.

It is contemplated herein that one or more inventive aspects may be embodied in computer-implemented steps automated to operate on various processing machines using one or more software programs, firmware, as well as signal processing circuitry or other electronically programmable hardware preferably accessible via one or more wired and/or wireless network. For example, during computationally automated operation, a network-accessible processor computationally renders interior space design elements to be extracted, saved, and/or applied automatically for 3D-reality space design, whereby computationally rendered 3D-reality space design transforms rendered design physically to actual 3D interior space. Optionally, at least one processor saves or loads coded elements that allow design elements to be applied into project(s) where coded and/or design elements form space characteristics. Such at least one processor may enable coded and/or design elements to be analyzed and/or coded into one or more database. Element characteristics may be categorized into parameter groups, such elements being applied into design space(s) as a set of “DNA” that may be user-changeable for alternate design proposal. Also, such at least one processor may code design elements, search using code values, or interchange element types with 3D rendering. Furthermore, such at least one processor may enable virtual-reality 3D walk-thru by communicating user, buyer, designer, or supplier to facilitate real-time interaction and design idea sharing.

Optionally, processor automates design-by-list approach, wherein in website or application, one or more user may generate design by creating a list of interior items, and processor or server automatically generates panorama view of such design in the space; preferably, user may repeat the process, and change items in the list, such that processor/server creates panorama and sends to user device according to latest change.

FIG. 2 illustrates representative apparatus embodiment diagram particularly system structure for rendering design according to one or more aspect of the present invention. As shown various software modules running on one or more sever or client computers, textures module 210 couples to materials module 214, which couples with meshes module 212 to products module 216 coupled to designs module 218, coupled to DNA module 220. Further coupled to such software modules, web client 222 uploads meshes and textures, edits product properties, provides simple design, extracts DNA from design, and provides design community access; PC client 224 edits mesh and material binding, and uses products to make full design; and mobile client 226 provides simple design, provides design community access, and virtual reality view.

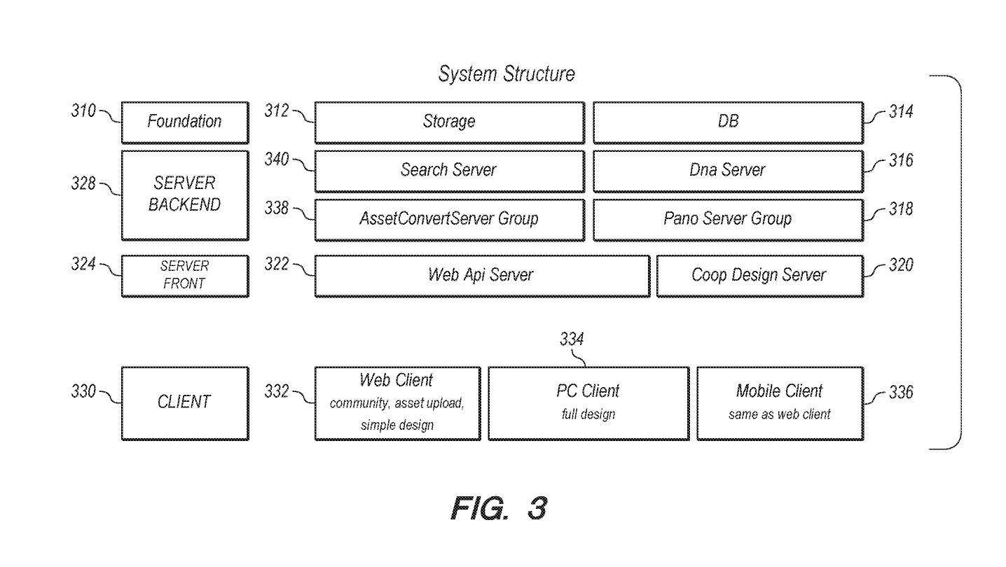

FIG. 3 illustrates representative apparatus embodiment diagram particularly system structure for rendering design according to one or more aspect of the present invention. As shown for one or more servers, system structure includes foundation 310, server backend 328, server front 324, storage 312, search server 340, asset convert server group 338, web API server 322, database 314, DNA server 316, pano server group 318, and coop design server. Also shown for one or more clients, system structure includes client 330, web client 332 for community, asset upload, and simple design, PC client 334 for full design, and mobile client 336 similarly to web client 332.

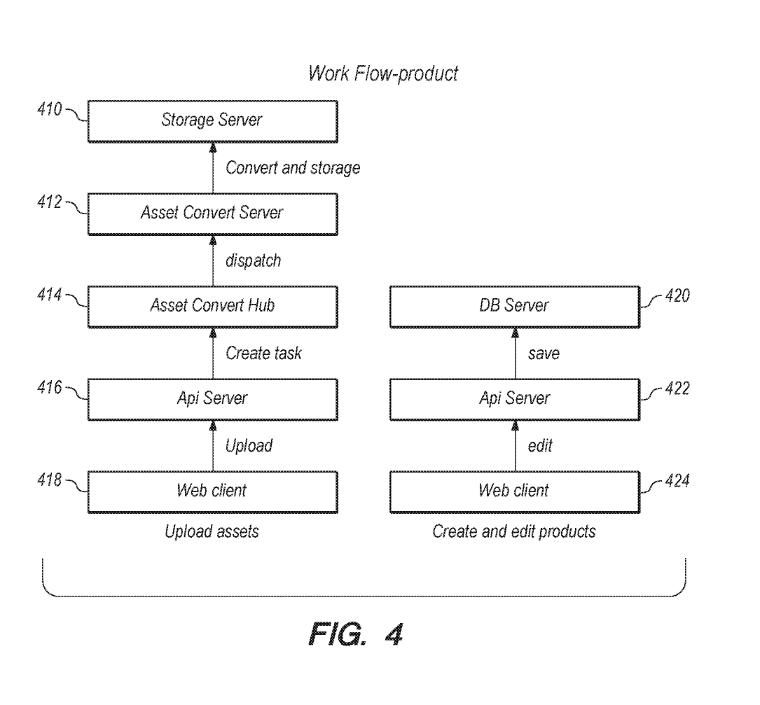

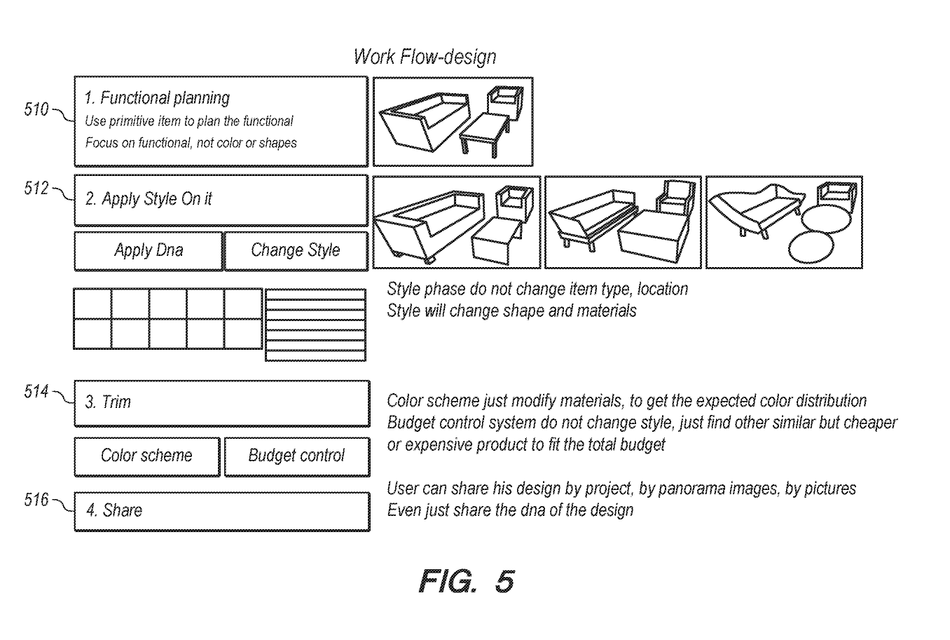

FIG. 4 illustrates representative apparatus and method embodiment diagram particularly work flow product for rendering design according to one or more aspect of the present invention. As shown for one or more servers, work flow product includes various manual and/or automated operational steps, e.g., web client uploading assets 418, API server creating task 416, asset convert hub dispatching 414, asset convert server converting 412, and storage server storing 410. Also shown for one or more clients, work flow product includes various manual and/or automated operating steps, e.g., web client creating and editing products 424, API server editing 422, and database server saving 420.

FIG. 5 illustrates representative apparatus and method embodiment diagram particularly work flow design for rendering design according to one or more aspect of the present invention. As shown for one or more server and/or client, work flow design includes various manual and/or automated operational steps, e.g., functional planning using primitive item(s) to plan functional focus on functional, not color or shapes 510, applying style by applying DNA and/or changing style 512, trimming using color scheme and/or budget control 514, and sharing 516. Optionally, style phase does not change item type, and/or location, and style may change shape and/or materials. Also, color scheme may modify materials to get expected color distribution, and budget control system may not change style, but find other similar cheaper or expensive product to fit total budget. Also, user may share design by product, by panorama images, by pictures, and/or by DNA of design.

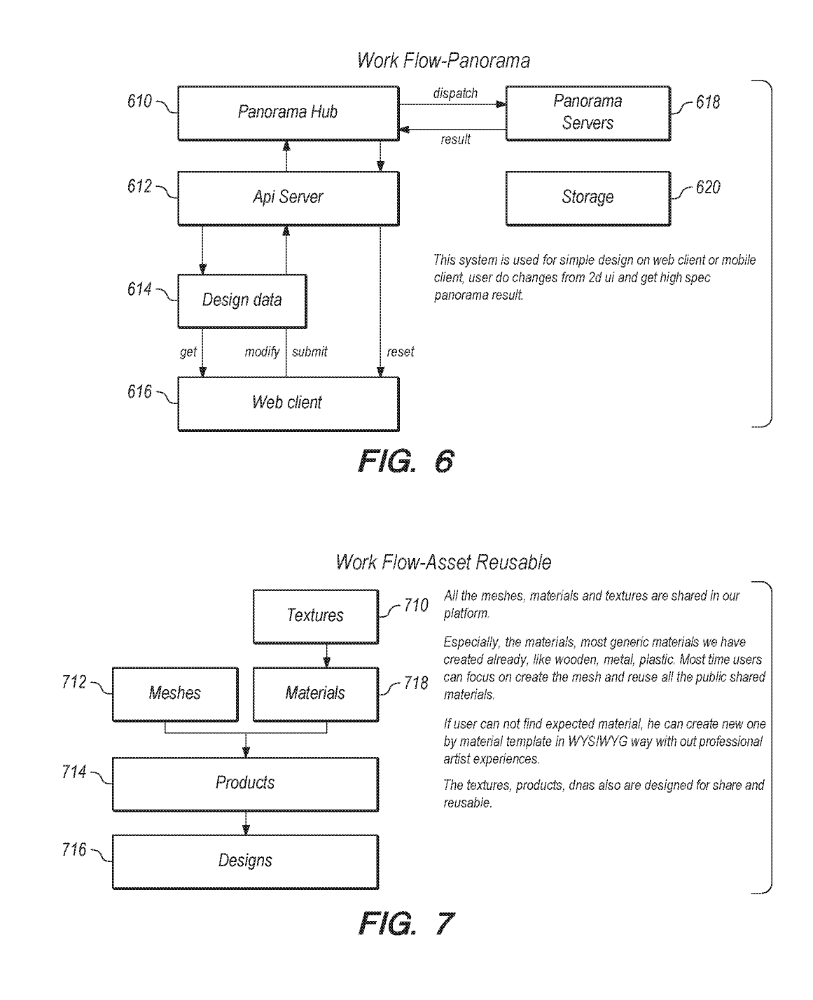

FIG. 6 illustrates representative apparatus and method embodiment diagram particularly work flow panorama design for rendering design according to one or more aspect of the present invention. As shown for one or more server and/or client, work flow panorama design includes various manual and/or automated operational steps, e.g., web client 616 getting design data 614/modifying and/or submitting design 614 data/receiving result from API server 612, panora ma hub 610 dispatching and/or receiving result to/from panorama servers 618 and storage 620. Optionally, this system may be used for simple design on web client or mobile client, and user does changes from 2-dimensional user interface and get high specification panorama result.

FIG. 7 illustrates representative apparatus and method embodiment diagram particularly work flow asset reusable system for rendering design according to one or more aspect of the present invention. As shown for one or more server and/or client, work flow design includes various manual and/or automated operational steps, e.g., textures module 710 couples to materials module 718, which couples with meshes module 712 to products module 216 coupled to designs module 716. Optionally, meshes, materials, and textures are share-able in the design platform. In particular, various materials are pre-provided, e.g., wood, metal, plastic, etc. Also, users may focus on creating meshes, and reuse share-able materials; and if user cannot find expected material, new materials may be created using material template in WYSIWYG way without professional artist experience or skill. Also, textures, products, DNAs are designed for share and/or reuse.

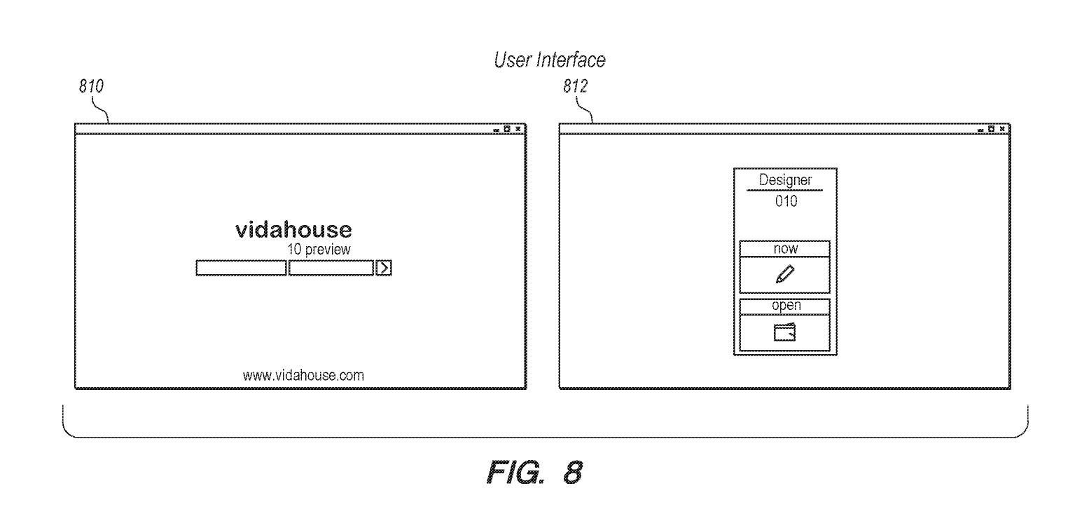

FIGS. 8-22 illustrate representative user interface diagrams for rendering design according to one or more aspect of the present invention. For example, such display interface includes user selectable audio/visual icons, buttons, or other multi-media or graphical means for user interaction to communicate or otherwise select computer-implemented items according to automated activity.

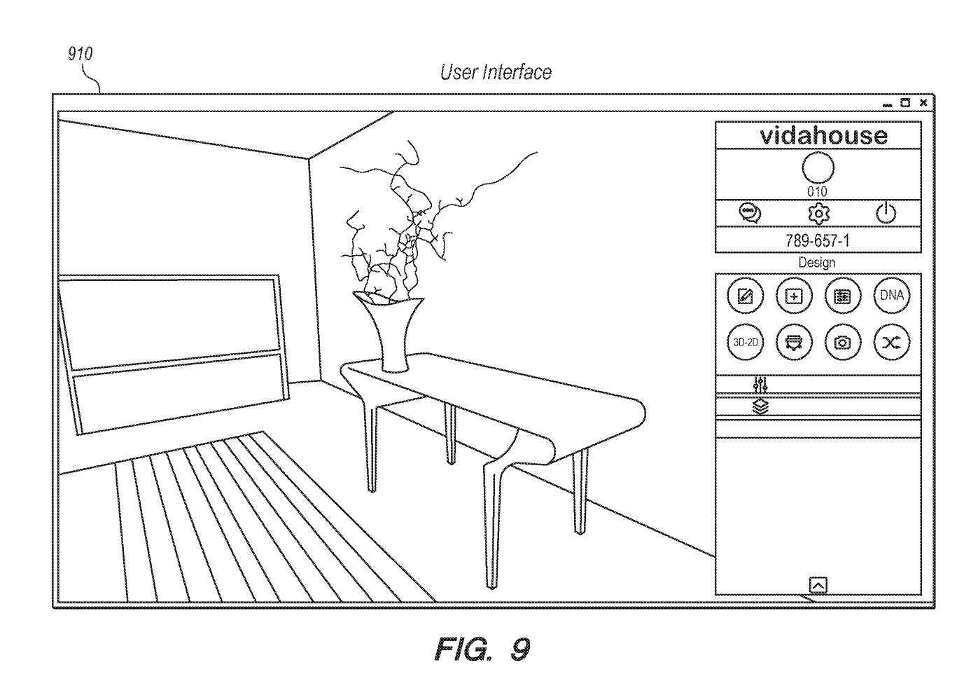

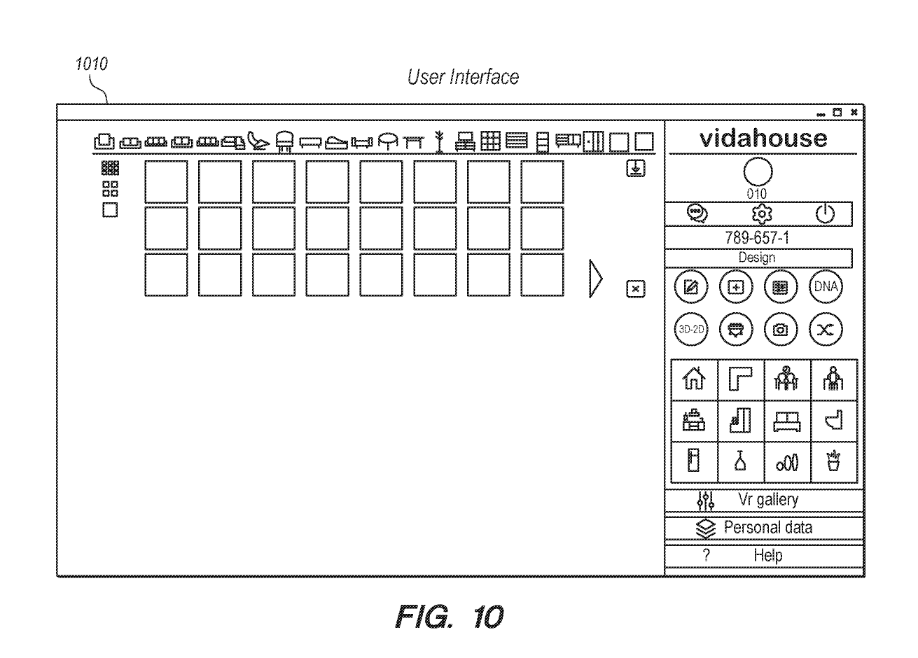

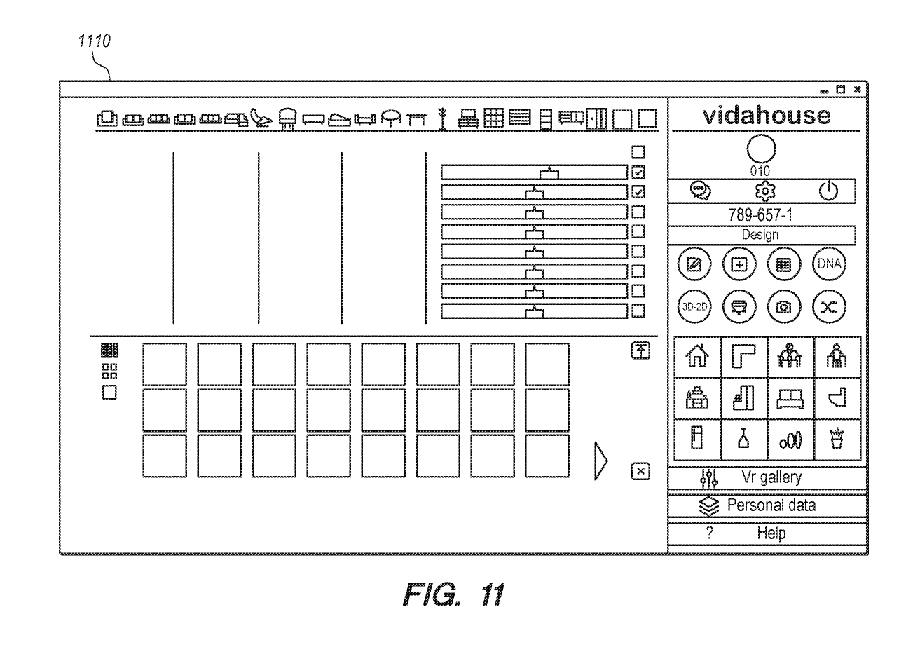

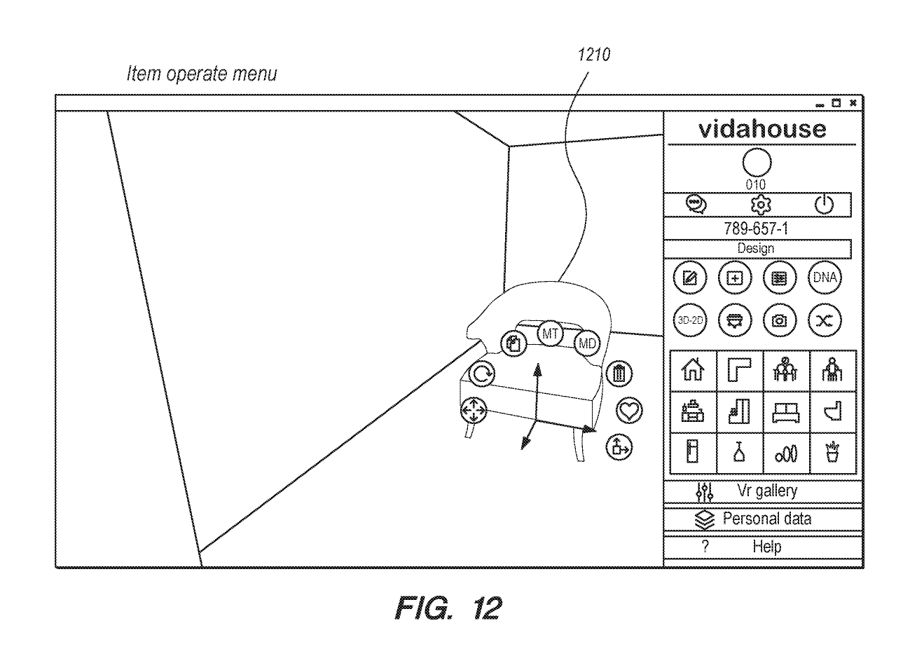

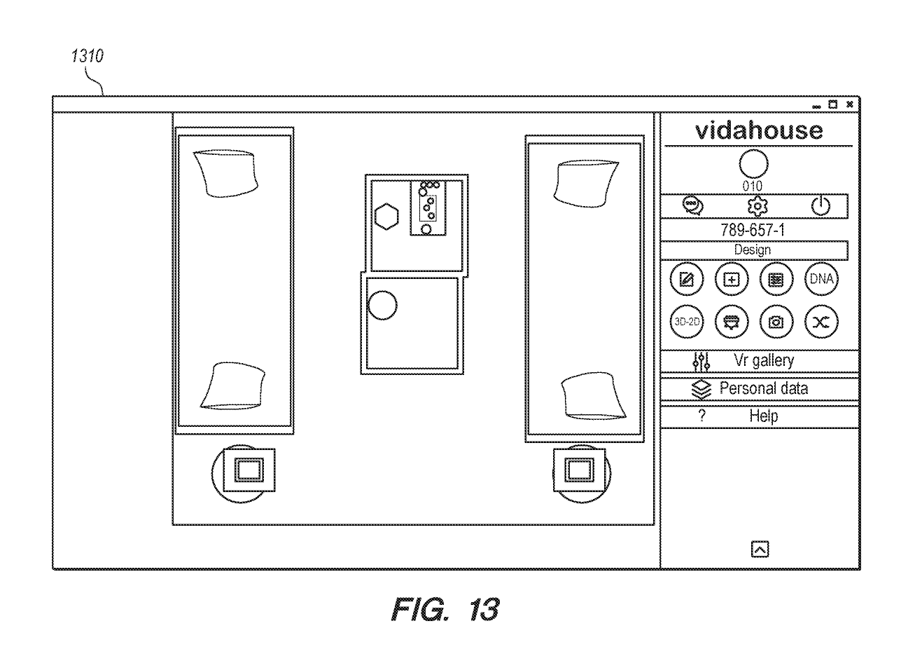

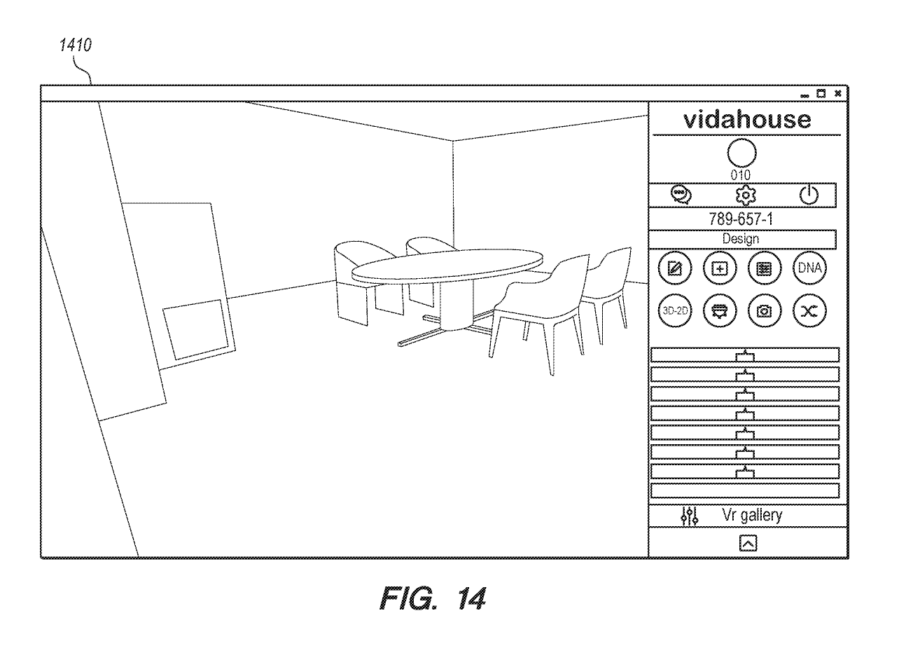

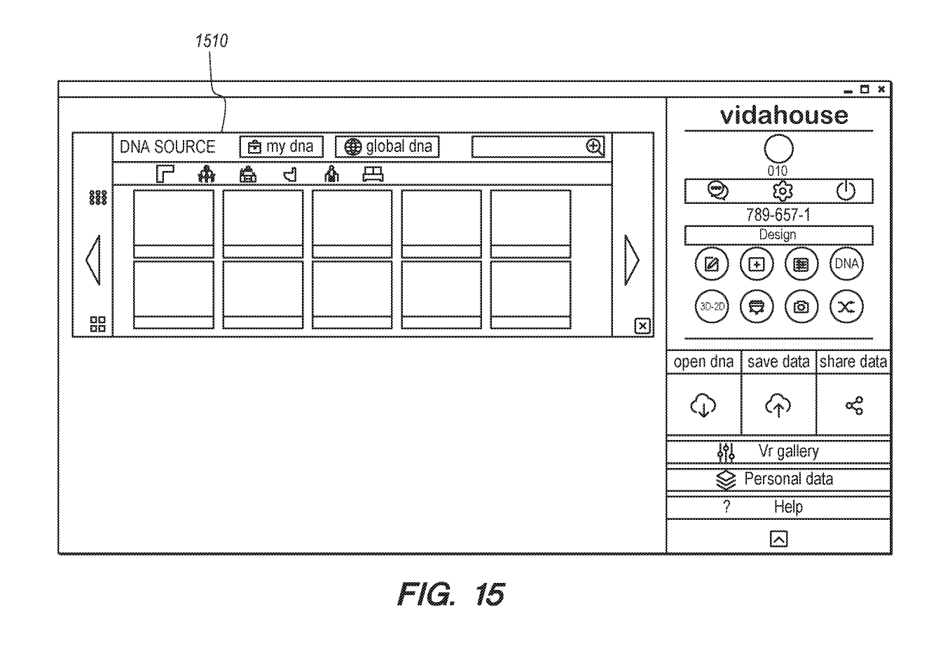

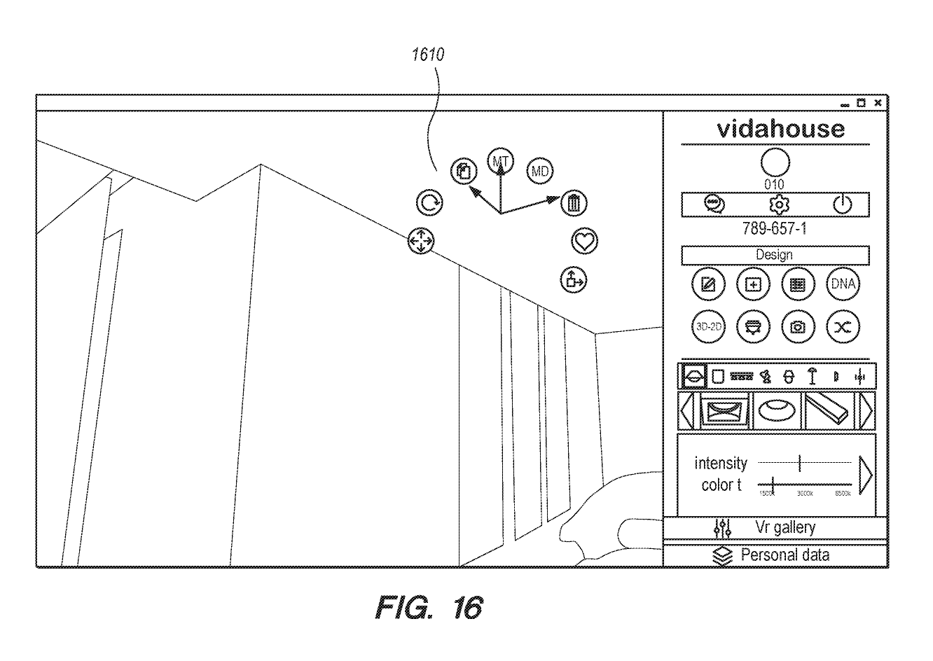

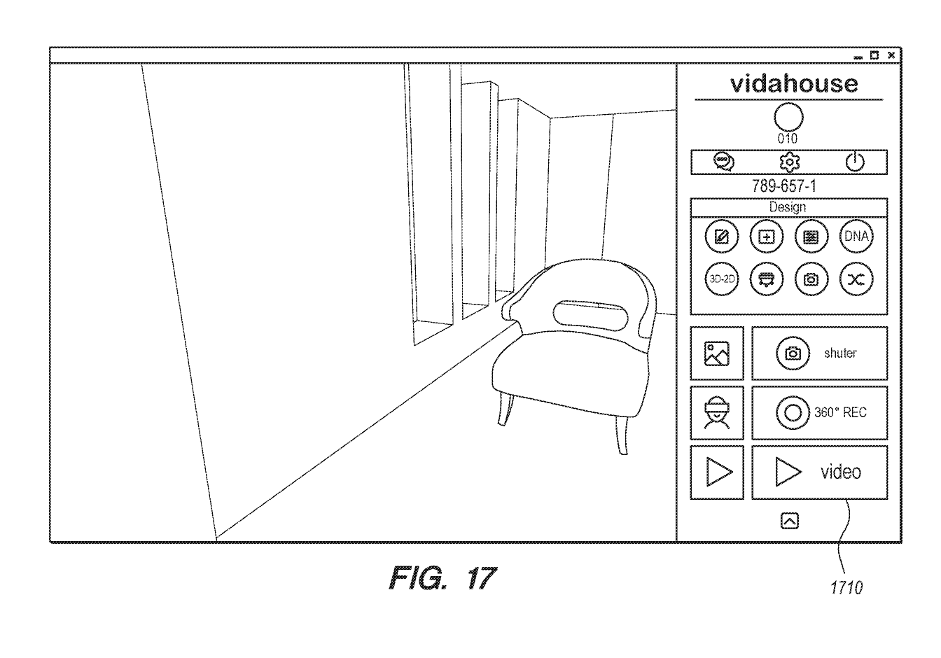

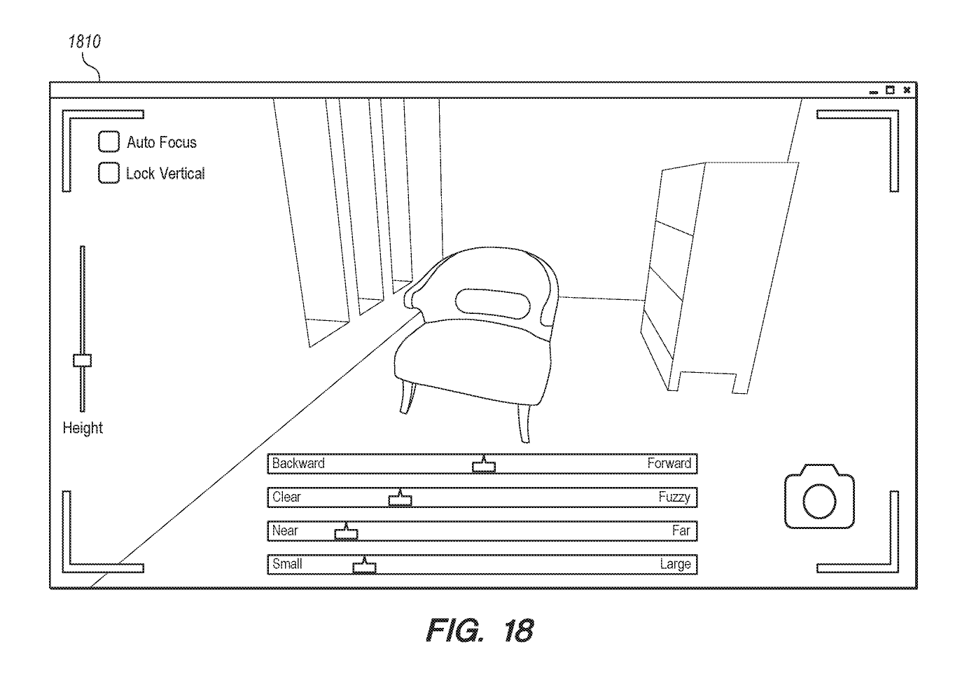

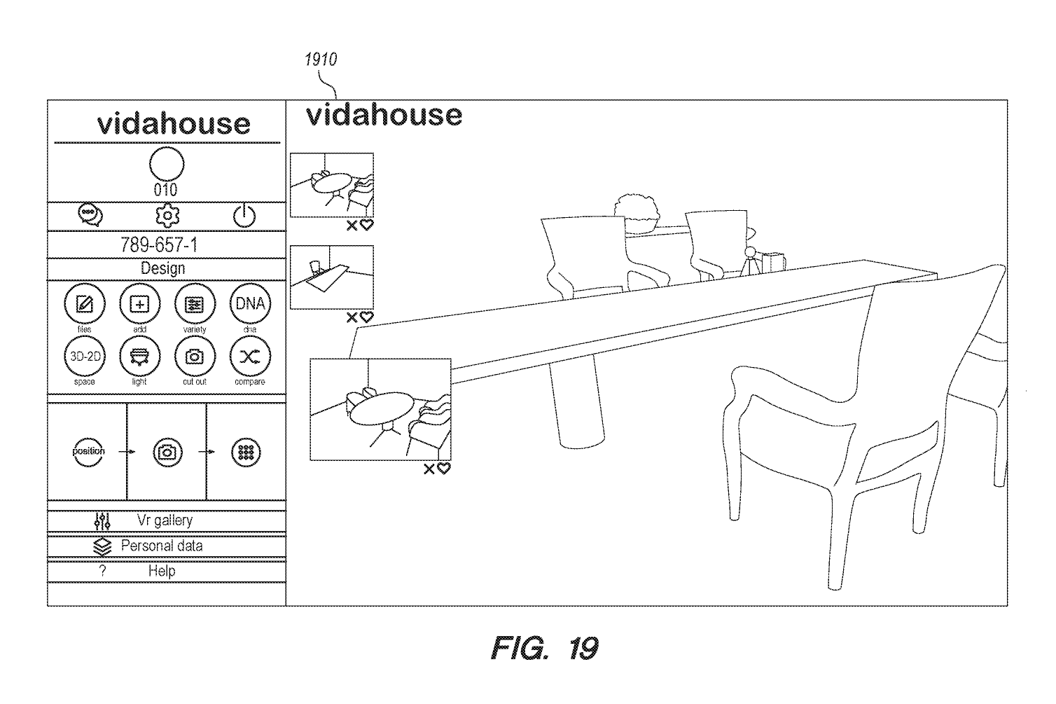

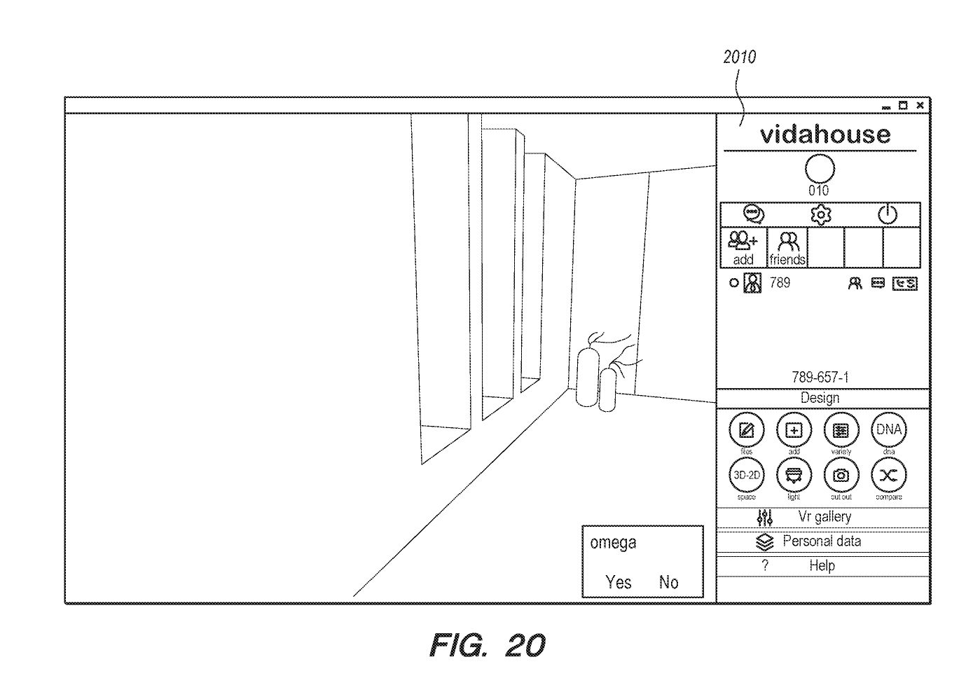

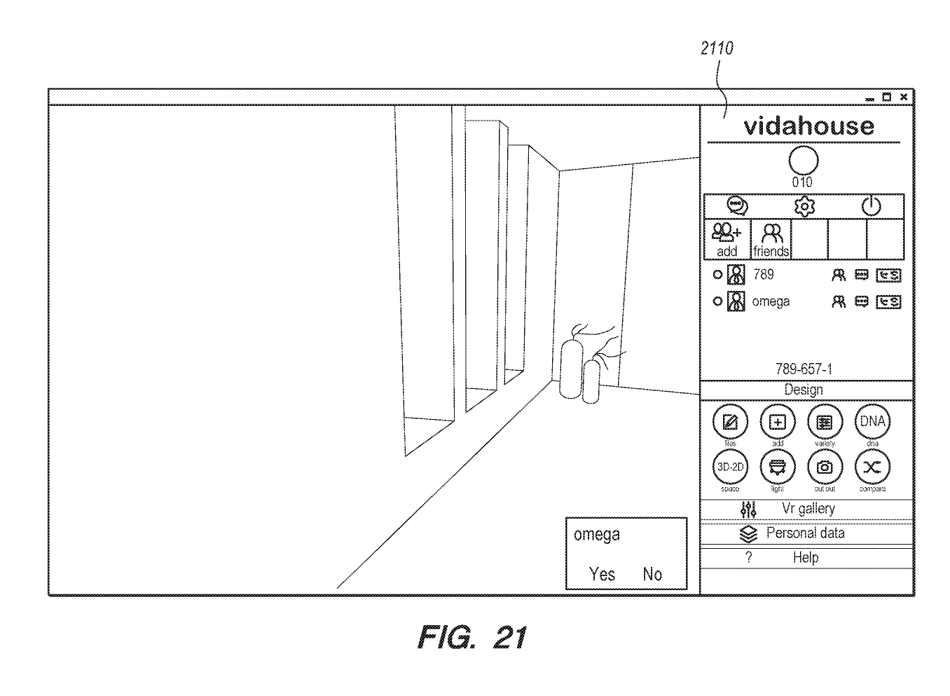

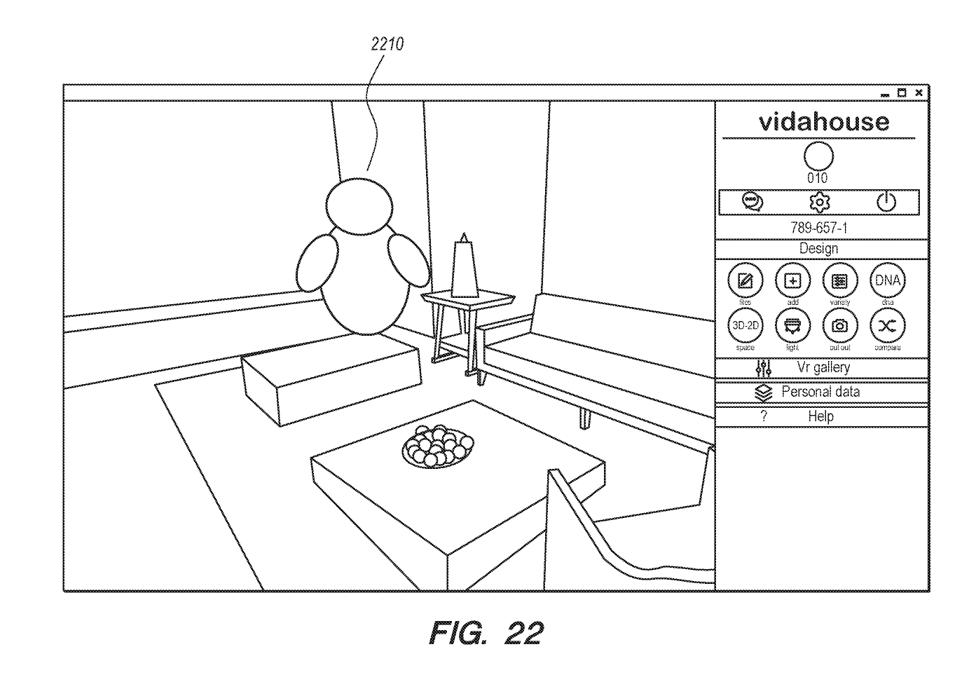

FIG. 8 shows representative interfaces 810, 812. FIG. 9 shows representative interface 910 with design and gallery menu. FIG. 10 shows representative interface 1010 with various object selections. FIG. 11 shows representative interface 1110 with various style selections. FIG. 12 shows representative interface 1210 with object control menu. FIG. 13 shows representative interface 1310 with top view. FIG. 14 shows representative interface 1410 with 3-dimensional view. FIG. 15 shows representative interface 1510 with various DNA source selections. FIG. 16 shows representative interface 1610 with various 3-dimensional control. FIG. 17 shows representative interface 1710 with video control. FIG. 18 shows representative interface 1810 with visual control. FIG. 19 shows representative interface 1910 with various viewing control. FIG. 20 shows representative interface 2010 with 3-dimensional view. FIG. 21 shows representative 2110 with 3-dimensional view. FIG. 22 shows representative interface 2210 with 3-dimensional view.

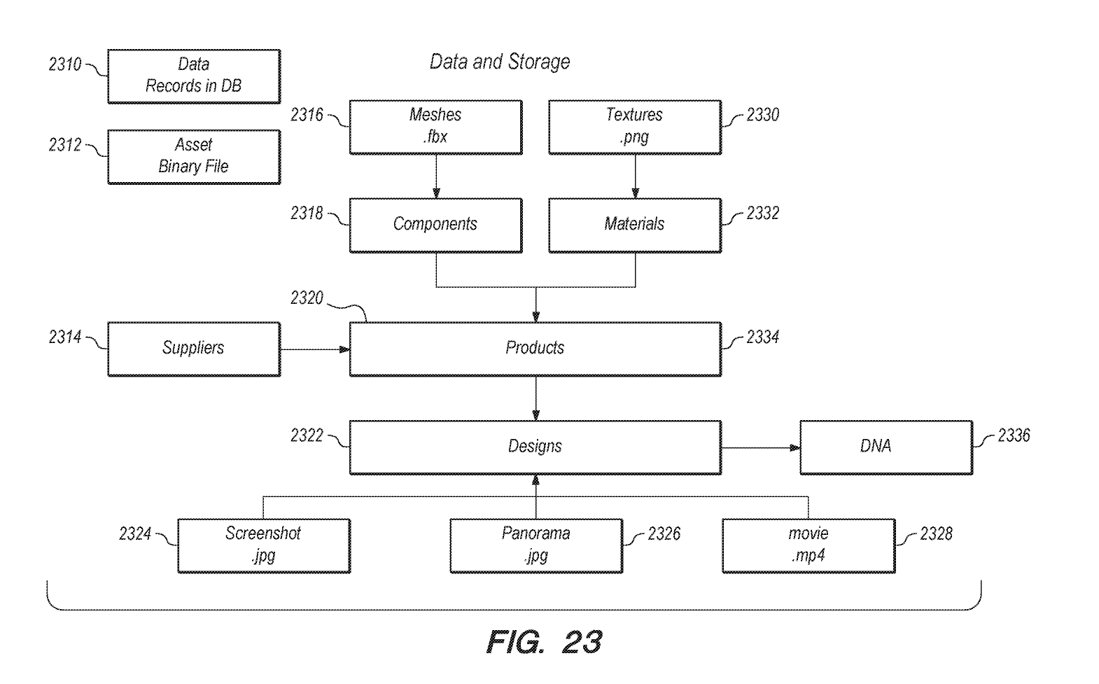

FIGS. 23-25 illustrate representative data, storage, and data structure for rendering design according to one or more aspect of the present invention.

As shown in FIG. 23, data 2310 and asset 2312 modules are provided with various software modules running on one or more sever or client computers, textures module 2330 couples to materials module 2332, which couples with meshes module 2316 and components module 2318 to products module 2334 and suppliers module 2314 coupled to designs module 2322, coupled to DNA module 2336, screenshot module 2324, panorama module 2326, and movie module 2328.

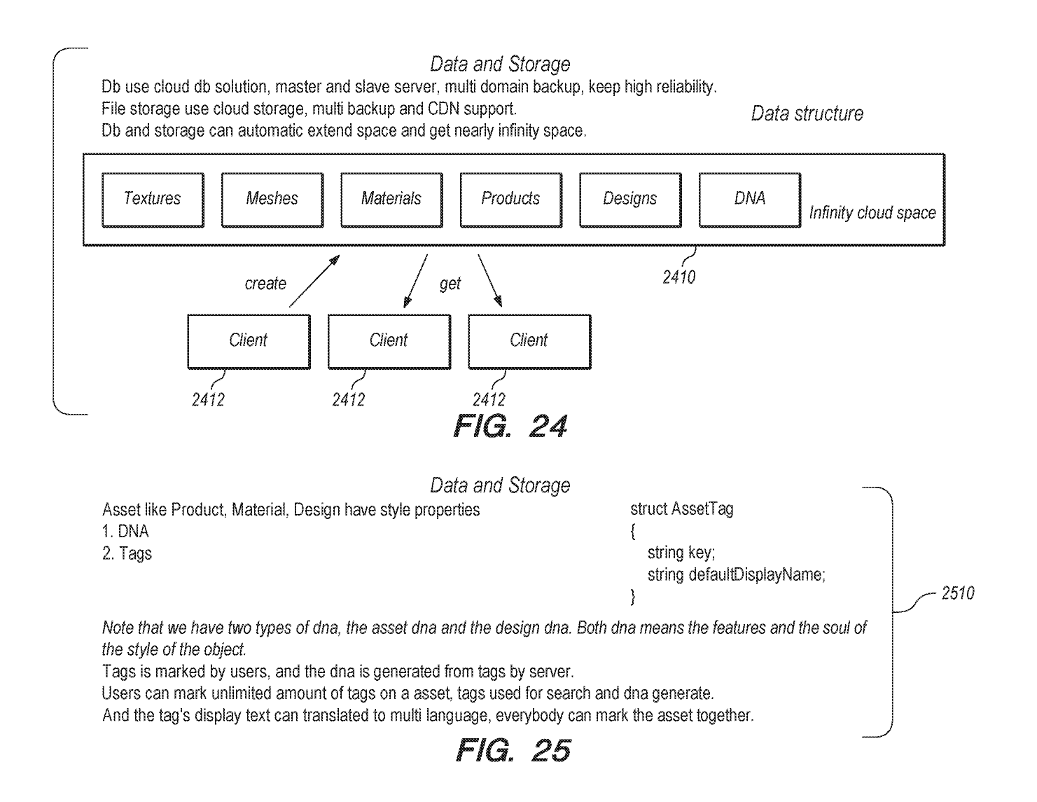

As shown in FIG. 24, infinity cloud space 2410 including network-accessible textures, meshes, materials, products, designs, DNA, etc., couples to various client 2412 for creating and/or otherwise getting design information. Optionally, database may use cloud database solution, master and/or slave server, multi-domain backup, thereby keeping high reliability. Also, file storage may use cloud storage, multi-backup and CDN support. Also, database and/or storage may automatically extend space, thereby generating nearly infinite space.

As shown in FIG. 25, data/storage structure 2510 is provided, such that assets like product, material, design have style properties, e.g., DNA, tags, etc. In particular, various DNA types may be provided, e.g., asset DNA, and design DNA, whereby asset and design DNA types represent features of object style. Also, tags may be marked by users; and DNA may be generated from tags by server. Also, users may mark unlimited amount of tags on an asset; and tags may be used for search and DNA generation. Optionally, tag display text may be translated to multiple languages, such that various users/community may mark such asset collaboratively.

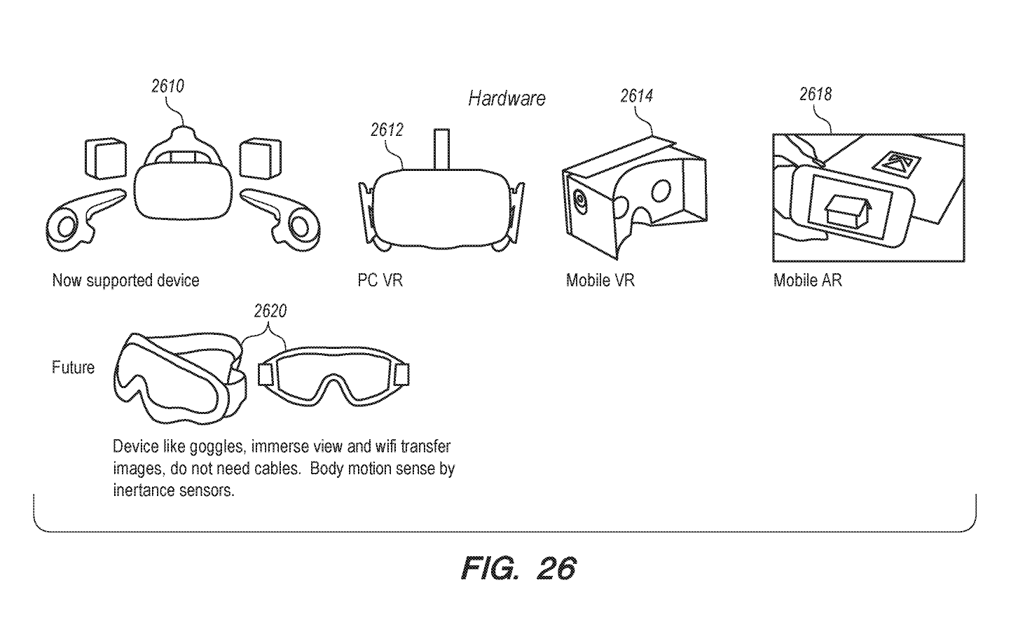

FIG. 26 illustrates representative hardware apparatus embodiment diagram for rendering design according to one or more aspect of the present invention. For example, various hardware embodiments 2610, 2612, 2614, 2618, 2620 are shown, including goggles, immersive view and WIFI transfer images, without needing cable wiring; as well as including body motion sensor using inertial sensing.

Foregoing descriptions of specific embodiments of the invention have been presented for purposes of illustration and description. They are not intended to be exhaustive or to limit the invention to the precise forms disclosed. Modifications and variations are possible in light of the above teaching. The embodiments were chosen and described in order to explain the principles and the application of the invention, thereby enabling others skilled in the art to utilize the invention in its various embodiments and modifications according to the particular purpose contemplated. The scope of the invention is intended to be defined by the claims appended hereto and their equivalents.

1. Online design platform comprising:
3D-reality rendering means for network-accessible interior space design;
wherein said rendering means computationally enables one or more combination of interior space design elements to be extracted, saved, and applied automatically to one or more alternate 3D-reality design space accessible online via the network.

2. The platform of claim 1 wherein said rendering means computationally enables saving and loading on a network-accessible platform one or more coded elements to allow design elements to be applied into new projects where these elements form new space characteristics.

3. The platform of claim 1 wherein said rendering means computationally enables one or more of said elements to be analyzed and coded automatically into a database, wherein one or more element characteristic is categorized into one or more parameter group, such one or more said element being applied into a given design space as a set of DNA, which is user-changeable for one or more alternate design proposal.

4. The platform of claim 1 wherein said rendering means computationally enables design-by-list automatically, wherein in website or application, one or more user generates design by creating a list of interior items, and said rendering means thereby generates panorama view of such design in design space.

5. The platform of claim 4 wherein user repeats or modifies design generation to change items in the list, such that said rendering means re-generates panorama and thereby sends a modified design list to user device according to such change.

6. The platform of claim 1 further comprising:
means for coding design elements;
means for searching using code values; and
means for interchanging element types with 3D rendering.

7. The platform of claim 1 wherein said rendering means computationally enables virtual-reality 3D walk-thru by one or more communicating user, buyer, designer, or supplier, thereby facilitating real-time interaction to share design ideas.

8. Online design method comprising step:
3D-reality rendering network-accessible interior space design;
wherein said rendering computationally enables one or more combination of interior space design elements to be extracted, saved, and applied automatically to one or more alternate 3D-reality design space accessible online via the network.

9. The method of claim 8 wherein said rendering computationally enables saving and loading on a network-accessible platform one or more coded elements to allow design elements to be applied into new projects where these elements form new space characteristics.

10. The method of claim 8 wherein said rendering computationally enables one or more of said elements to be analyzed and coded automatically into a database, wherein one or more element characteristic is categorized into one or more parameter group, such one or more said element being applied into a given design space as a set of DNA, which is user-changeable for one or more alternate design proposal.

11. The method of claim 8 further comprising steps:
coding design elements;
searching using code values; and
interchanging element types with 3D rendering.

12. The method of claim 8 wherein said rendering computationally enables virtual-reality 3D walk-thru by one or more communicating user, buyer, designer, or supplier, thereby facilitating real-time interaction to share design ideas.

13. The method of claim 8 wherein said processor computationally enables design-by-list automatically, wherein in website or application, one or more user generates design by creating a list of interior items, and said processor thereby generates panorama view of such design in design space.

14. The method of claim 8 wherein said processor computationally enables design-by-list automatically, wherein in website or application, one or more user generates design by creating a list of interior items, and said processor thereby generates panorama view of such design in design space.

15. The method of claim 14 wherein user repeats or modifies design generation to change items in the list, such that said processor re-generates panorama and thereby sends a modified design list to user device according to such change.

16. 3D-reality rendering apparatus for network-accessible interior space design comprising:
a network-accessible processor that computationally renders interior space design elements to be extracted, saved, and applied automatically for 3D-reality space design;
whereby said computationally rendered 3D-reality space design is physically transformed into an actual 3D interior space design.

17. The apparatus of claim 16 wherein said processor computationally saves and loads coded elements that allow design elements to be applied automatically into one or more project where such coded or design elements form new space characteristics.

18. The apparatus of claim 16 wherein said processor computationally enables one or more of said coded or design elements to be analyzed and coded automatically into a database, wherein one or more element characteristic is categorized into one or more parameter group, such coded or design elements being applied into a given design space as a set of DNA, which is user-changeable for one or more alternate design proposal.

19. The apparatus of claim 16 wherein said processor computationally codes design elements, searches using code values, or interchanges element types with 3D rendering.

20. The apparatus of claim 16 wherein said processor computationally enables virtual-reality 3D walk-thru by one or more communicating user, buyer, designer, or supplier, thereby facilitating real-time interaction to share design ideas.

21. The apparatus of claim 16 wherein said processor computationally enables design-by-list automatically, wherein in website or application, one or more user generates design by creating a list of interior items, and said processor thereby generates panorama view of such design in design space.

22. The apparatus of claim 21 wherein user repeats or modifies design generation to change items in the list, such that said processor re-generates panorama and thereby sends a modified design list to user device according to such change.
